(19) United States
(12) Patent Application Publication
(10) Pub. No.: US 2014/0132808 A1
(43) Pub. Date: May 15, 2014

(54) METHOD AND APPARATUS FOR INTERPOLATING COLOR

(71) Applicant: Samsung Electronics Co., Ltd., Suwon-si (KR)

(72) Inventors: Dong Jae LEE, Osan-si (KR); Byung Joon BAEK, Goyang-si (KR); Tae Chan KIM, Yongin-si (KR)

(73) Assignee: Samsung Electronics Co., Ltd., Suwon-si (KR)

(21) Appl. No.: 14/044,178

(22) Filed: Oct. 2, 2013

(30) Foreign Application Priority Data
Nov. 12, 2012 (KR) 10-2012-0127253

(51) Int. Cl. H04N 9/04

(52) U.S. Cl. CPC H04N 9/045
USPC 348/253

(57) ABSTRACT

A method for interpolating a color includes interpolating, in a first pixel of a first color, a first pixel value based on pixel values of pixels adjacent to the first pixel, skipping an interpolation on a second pixel of a second color corresponding to the first pixel of the first color; and generating an image based on the interpolated first pixel value and an uninterpolated pixel value of the second pixel.

### CROSS-REFERENCE TO RELATED APPLICATION

Korean Patent Application No. 10-2012-0127253, filed on Nov. 12, 2012, and entitled: “Method and Apparatus for Interpolating Color,” which is incorporated by reference herein in its entirety.

### BACKGROUND

1. Field

Embodiments herein relate to display devices.

2. Description of the Related Art

An image sensor converts an optical image signal into an electrical image signal. To produce a color image, pixels which emit light of different may be included in the image sensor. When a driving signal of a color (e.g., a red pixel value, green pixel value, or blue pixel value) is missing at each pixel location, a digital imaging process for estimating the missing pixel value may be performed. Examples of a digital imaging process of this type include a demosaicing algorithm and an interpolation algorithm. However, these and other digital imaging processes have proven to have drawbacks, not the least of which includes computational complexity.

### SUMMARY

Embodiments are directed to a method for generating an image by interpolating one or more pixel values of a predetermined color.

In accordance with one embodiment, a method for interpolating a color includes interpolating, in a first pixel of a first color, a first pixel value based on pixel values of pixels adjacent to the first pixel; skipping an interpolation on a second pixel of a second color corresponding to the first pixel of the first color; and generating an image based on the interpolated first pixel value and an uninterpolated pixel value of the second pixel. The first pixel may be included in a first layer, the second pixel may be included in a second layer, and the first layer and the second layer may be vertically stacked.

Also, the first layer may have a pattern of pixels of the first color and a third color, and the second layer may include pixels of the second color corresponding to the pixels the pattern of the first layer. The pattern may include an alternating pattern of pixels of the first color and the third color. The first layer may be over the second layer, or the second layer may be over the first layer. The first interpolated pixel value in the first pixel may computed by Bilinear interpolation, by Constant Hue base interpolation, or by edge sensing interpolation.

In accordance with another embodiment, a device includes a pixel array including a first layer having a first pixel and a second layer having a second pixel; and an image signal processor which interpolates a first pixel value in the first pixel based on pixel values of pixels adjacent to the first pixel output from the pixel array, which skips interpolation of the second pixel, and which generates an image based on the interpolated first pixel value and an uninterpolated pixel value of the second pixel.

Also, the first layer and the second layer may be vertically stacked. The first layer may include a third pixel, and the first pixel and the third pixel are disposed in a predetermined pattern. The predetermined pattern may be an alternating pattern of first and third pixels.

Also, the first interpolated pixel value in the first pixel may be computed by Bilinear interpolation, by Constant Hue based interpolation, or by edge sensing interpolation. The first pixel may be a blue pixel or a red pixel, and the second pixel may be a green pixel. The second layer may be formed of an organic photoelectric-conversion film.

Also, the first layer has a pattern of pixels of the first color and a third color, and the second layer includes pixels of the second color corresponding to the pixels the pattern of the first layer, wherein the pattern of pixels includes an alternating pattern of pixels of the first and third colors.

### BRIEF DESCRIPTION OF THE DRAWINGS

Features will become apparent to those of ordinary skill in the art by describing in detail exemplary embodiments with reference to the attached drawings in which:

FIG. 1 illustrates an embodiment of a pixel array;

FIG. 2 illustrates an example of a first layer in FIG. 1;

FIG. 3 illustrates an example of a second layer illustrated in FIG. 1;

FIG. 4 illustrates an image sensing system including the pixel array in FIG. 1;

FIG. 5 illustrates an embodiment of a method for interpolating color;

FIG. 6 illustrates operations included in the method in FIG. 5; and

FIG. 7 illustrates another image sensing system including the pixel array in FIG. 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

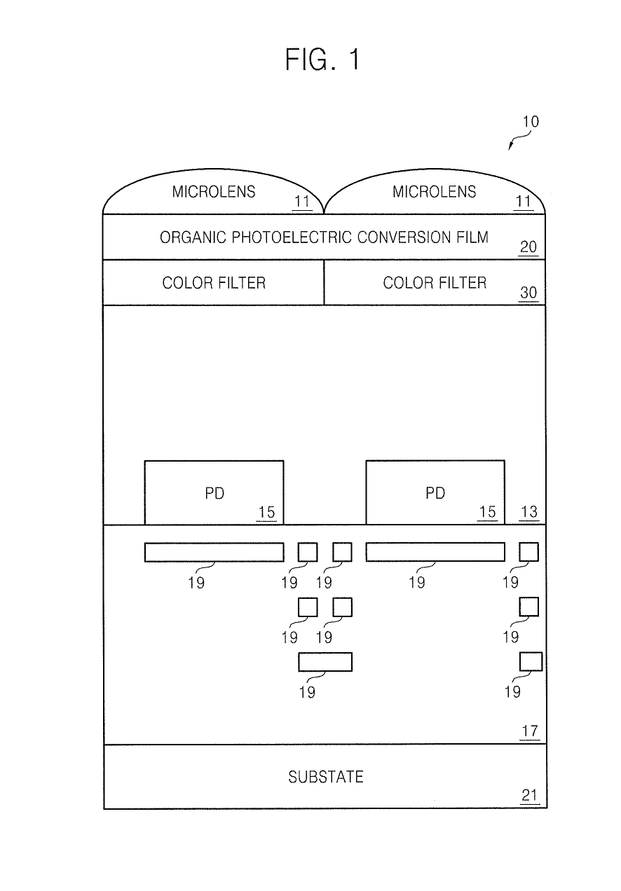

FIG. 1 illustrates an embodiment of a pixel array 10 which includes a microlens 11, a first layer 20, a second layer 30, an epitaxial layer 13, an inter-metal dielectric layer 17, and a substrate 21.

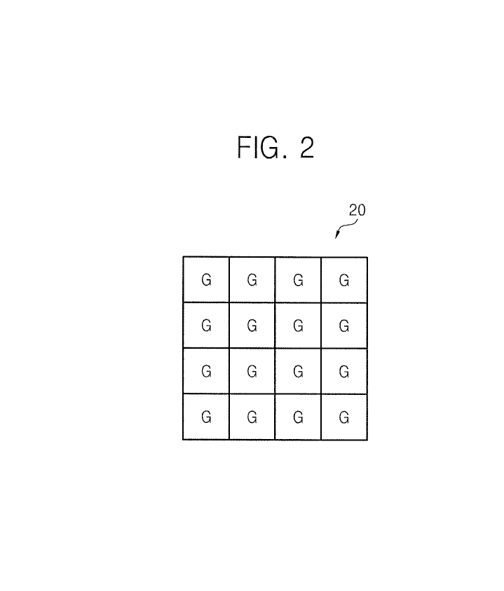

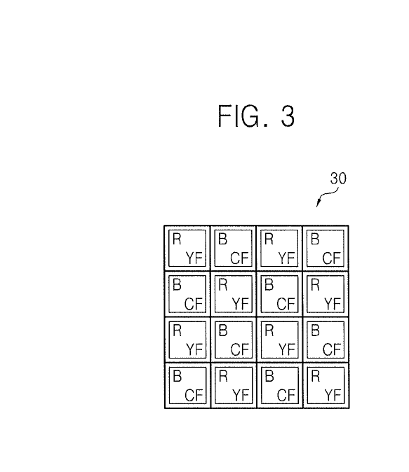

The microlens 11 collects light incident from an external source. In an alternative embodiment, the pixel array 10 may be embodied without the microlens 11. The first layer 20 and the second layer 30 will be described in detail referring to FIGS. 2 and 3.

A photo-detector 15 generates photoelectrons in response to light incident from an external source. The photo-detector 15 is formed in the epitaxial layer 13. The photo-detector 15 may be formed by or include a photodiode, a phototransistor, a photogate, or a pinned photodiode (PPD) as a photosensitive element.

The inter-metal dielectric layer 17 may be formed of an oxide layer or a composite layer of an oxide layer and a nitride layer. The oxide layer may be a silicon oxide layer. The inter-metal dielectric layer 17 may include metal patterns 19.

Electrical wiring required for a sensing operation of the pixel array may be formed of the metal patterns 19. In addition, according to an example embodiment, the metal patterns 19 may be used to reflect light incident through the photo-detector 15 back to the photo-detector 15. The metal patterns 19 may be copper, titanium, or titanium nitride. The substrate 21 may be a silicon substrate.

FIG. 2 illustrates an example of the first layer in FIG. 1 and FIG. 3 illustrates an example of the second layer in FIG. 1. Referring to FIGS. 1 to 3, in one embodiment, the first layer 20 may include green pixels G and, for example, may be formed of an organic photoelectric-conversion film.

The second layer 30 includes red pixels R and blue pixels B disposed in a predetermined pattern. In the example, shown the predetermined pattern is a checker pattern. Although, the red and blue pixels may be disposed in a different pattern.

Also, as shown in FIG. 1, the first layer 20 and the second layer 30 are vertically stacked, with the first layer 20 being over the second layer 30. In alternative embodiments, the positions of the first layer 20 and the second layer 30 may be reversed, e.g., layer 30 may be over layer 20. Also, in FIG. 1, the first and second layers are shown to be in direct contact with one another. However, in alternative embodiments, one or more intervening layers may be positioned between the first and second layers 20 and 30. Examples of these intervening layers may include a polarizing layer.

Herein, the term ‘pixel’ may be understood to correspond to a component unit generating a color pixel signal having a color pixel value. For example, a green pixel G denotes a component unit generating a green pixel signal having a green pixel value corresponding to wavelengths belonging to a green region of visible light spectrum. A red pixel R denotes a component unit generating a red pixel signal having a red pixel value corresponding to wavelengths belonging to a red region of the visible light spectrum. A blue pixel B denotes a component unit generating a blue pixel signal having a blue pixel value corresponding to wavelengths belonging to a blue region of the visible light spectrum.

The green pixel G may absorb wavelengths of the green region of the visible light spectrum and generate a green pixel signal having a green pixel value corresponding to wavelengths belonging to the green region. That is, the green pixel G converts visible light including wavelengths of the green region into a green pixel signal. Wavelengths of the remaining regions, except for wavelengths belonging to the green region and absorbed by the green pixel G in the visible light, pass through the second layer 30.

The red pixel R may include a yellow organic color filter YF and the photo-detector 15. The yellow organic color filter YF absorbs wavelengths of a blue region among wavelengths of the remaining region, so as to remove wavelengths belonging to the blue region from wavelengths of the remaining regions. The yellow organic color filter YF does not remove wavelengths belonging to the green region to be absorbed by the green pixel G in the visible light spectrum.

The photo-detector 15 converts wavelengths of the visible light, passing through the red pixel R, into a red pixel signal. That is, the red pixel R generates a red pixel signal having a red pixel value using the photo-detector 15.

A blue pixel B may include a cyan organic color filter CF and photo-detector 15.

The cyan organic color filter CF absorbs wavelengths of the red region, so as to remove wavelengths belonging to the red region from wavelengths of the remaining regions, but does not remove wavelengths belonging to a green region absorbed by a green pixel G in the visible light spectrum.

The photo-detector 15 converts wavelengths of the visible light, passing through the blue pixel B, into a blue pixel signal. That is, the blue pixel B generates a blue pixel signal having a blue pixel value using the photo-detector 15.

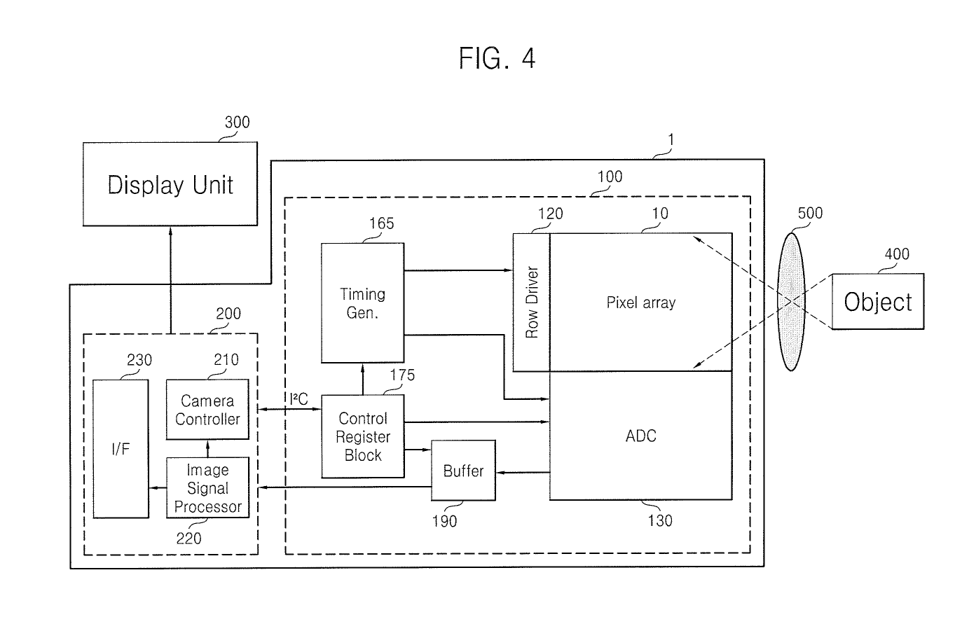

FIG. 4 illustrates an image sensing system including the pixel array in FIG. 1. Referring to FIGS. 1 and 4, an image sensing system 1 includes an image sensor 100 and a digital signal processor 200.

The image sensing system 1 may sense an object 400 imaged through a lens 500 by control of the digital signal processor 200. The digital signal processor 200 may output a color image sensed and output by the image sensor 100 to a display unit 300. The display unit 300 may be any display device capable of outputting an image. For example, the display unit 300 may be one included in or coupled to a computer, a cellular phone, or another type of image output terminal.

The digital signal processor 200 may include a camera controller 210, an image signal processor 220, and an interface (I/F) 230. The camera controller 210 controls a control register block 175. The camera controller 210 may control the image sensor 100, i.e., the control register block 175, using an Inter-Integrated Circuit (I2C); however embodiments are not restricted thereto.

The image signal processor (ISP) 220 receives digital pixel signals output from a buffer 190, processes the received digital pixel signals to be easily visible to people, and outputs the processed image to the display unit 300 through the PC I/F 230. For example, the ISP 220 may perform an interpolation operation using digital pixel signals output from the image sensor 100.

In FIG. 4, the image signal processor 220 is shown to be located inside the digital signal processor 200. However, the location of the image signal processor 220 may be different in other embodiments. For example, the image signal processor 220 may be located inside the image sensor 100.

The image sensor 100 includes the pixel array 10 illustrated in FIG. 1, a row driver 120, an analog-to-digital converter (ADC) 130, a timing generator 165, a control register block 175, and a buffer 190.

The pixel array 10 may include pixels in a matrix form connected with a plurality of row lines and a plurality of column lines, respectively.

The timing generator 165 may control an operation of the row driver 120 and the ADC 130 by outputting control signals to each of the row driver 120 and the ADC 130. The control register block 175 may control each operation of the timing generator 165 and the buffer 190 by outputting control signals to each of the timing generator 165 and the buffer 190. Here, the control register block 175 operates based on the control of the camera controller 210. The camera controller 210 may be embodied in hardware or software.

The row driver 120 may drive the pixel array 10 row by row. For example, the row driver 120 may generate a row selection signal. That is, the row driver 120 may decode a row control signal, e.g., an address signal, generated by the timing generator 165, and select at least one row line from row lines included in the pixel array 10 in response to the decoded row control signal. In addition, the pixel array 10 outputs pixel signals from a row, selected by a row selection signal provided from the row driver 120, to the ADC 130.

The ADC 130 converts pixel signals output from the pixel array 10 into digital pixel signals and outputs the digital pixel signals to the buffer 190.

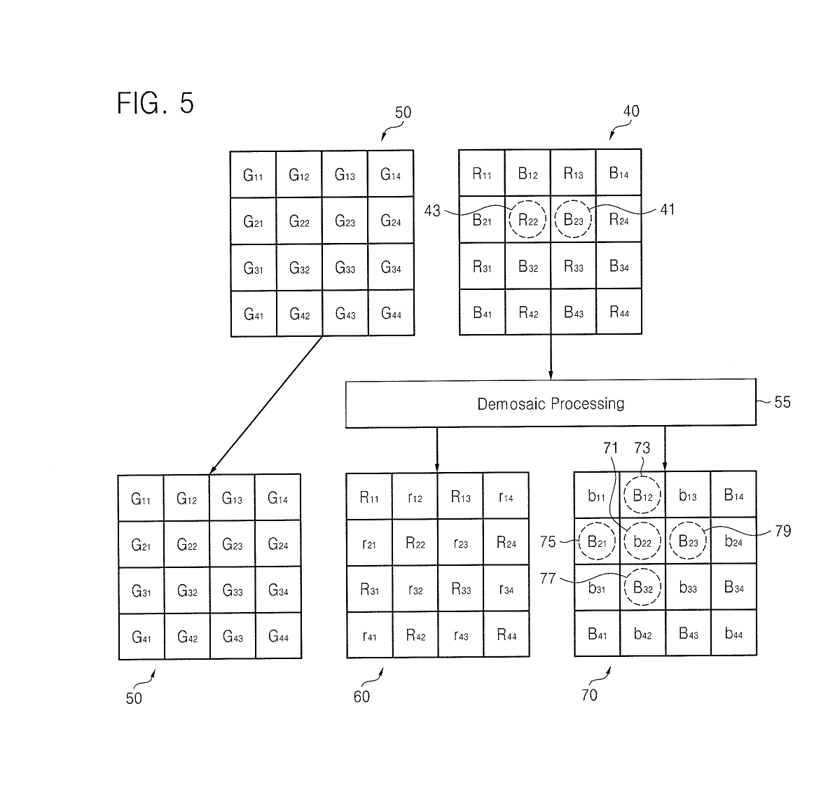

FIG. 5 illustrates one embodiment of a method for interpolating color. Referring to FIGS. 1 to 5, the image sensor 100 outputs pixel signals 40 and 50 having color pixel values to the digital signal processor 200. The pixel signals 40 and 50 may be digital signals.

The pixel signals 40 are output from the blue pixels B and the red pixels R in the second layer 30. The locations of the pixel signals 40 correspond to respective locations of pixels B or R of the second layer 30. Blue pixel signals B₁₂, B₁₄, B₂₁, B₂₃, B₃₂, B₃₄, B₄₁, and B₄₃ indicate blue pixel values of corresponding ones of the blue pixel signals output from the blue pixels B of the second layer 30. Red pixel signals R₁₁, R₁₃, R₂₂, R₂₄, R₃₁, R₃₃, R₄₂, and R₄₄ indicates red pixel values of corresponding ones of the red pixel signals output from red pixels R of the second layer 30.

Green pixel signals 50 are output from the green pixels G of the first layer 20. The locations of the green pixel signals 50 correspond to respective locations of green pixel G of the first layer 20. Green pixel signals G₁₁, G₁₂, G₁₃, G₁₄, G₂₁, G₂₂, G₂₃, G₂₄, G₃₁, G₃₂, G₃₃, G₃₄, G₄₁, G₄₂, G₄₃, and G₄₄ indicate green pixel values of corresponding ones of the green pixel signals output from the green pixels G of the first layer 20. The image sensor 100 outputs green pixel signals 50 per green pixel G, so that demosaic processing is not required on each green pixel G.

The numbers of blue pixels B and red pixels may be different from the number of green pixels. For example, in accordance with one embodiment, the number of blue pixels B and the number of red pixels R, which are arranged on the second layer 30, may be half of the number of green pixels G arranged on the first layer 20. Accordingly, each of the number of blue pixel signals and the number of red pixel signals are a half of the number of green pixel signals, respectively.

As shown in FIG. 5, a blue pixel signal having a blue pixel value B₂₃ is output from a blue pixel 41. However, a red pixel signal having a red pixel value is not output from the blue pixel 41. Therefore, a method for interpolating a red color in the blue pixel 41 is needed. That is, demosaic processing may be performed for interpolating a red pixel value in the blue pixel 41.

Similarly, a red pixel signal having a red pixel value R₂₂ is output from the red pixel 43. However, a blue pixel signal is not output from the red pixel 43. Accordingly, a method for interpolating a blue pixel value in the red pixel 43 is needed. That is, demosaic processing may be performed for interpolating a blue pixel value in the red pixel 43. Demosaic processing may be performed, for example, by the image signal processor 220.

Red pixel signals 60 include red pixel signals output from the red pixels R and red pixel signals having red pixel values interpolated obtained after the demosaic processing, in block 55. The symbols r₁₂, r₁₄, r₂₁, r₂₃, r₃₂, r₃₄, r₄₁, and r₄₃ indicate interpolated red pixel values.

Blue pixel signals 70 include blue pixel signals output from the blue pixels B and blue pixel signals having the interpolated blue pixel values obtained after the demosaic processing in block 55. The symbols b₁₁, b₁₃, b₂₂, b₂₄, b₃₁, b₃₃, b₄₂, and b₄₄ indicate interpolated blue pixel values. Each interpolated red pixel value and/or each interpolated blue pixel value may be computed by using pixel values of adjacent pixels.

In accordance with one embodiment, the interpolated blue pixel values may be computed based on Equation 1:

b_{xy}=(B_{(x-1)y}+B_{x(y-1)}+B_{x(y+1)}+B_{(x+1)y)})/4 (1)

In Equation 1, the symbol b_{xy} indicates an interpolated blue pixel value in a red pixel, x indicates a row, y indicates a column, symbols B_{(x-1)y}, B_{x(y-1)}, B_{x(y+1)}, and B_{(x+1)y} indicate blue pixel values of adjacent blue pixels to the red pixel. For example, the interpolated blue pixel value b₂₂ may be computed based on blue pixel values B₁₂, B₂₁, B₂₃, and B₃₂ of adjacent blue pixels 73, 75, 77, and 79 to a red pixel 71. A location of the red pixel 71 corresponds to a location of the red pixel 43. When the blue pixel value b₂₂ is interpolated using the Equation 1, Bilinear interpolation may be defined.

In accordance with the same or another embodiment, a blue pixel value may be interpolated based on Equation 2.

b_{xy}=G_{xy}+(B_{avg}−G_{avg}) (2)

In accordance with this same or another embodiment, B_{avg} and G_{avg} may be computed based on Equations 3 and 4:

B_{avg}=(B_{(x-1)y}+B_{x(y-1)}+B_{x(y+1)}+B_{(x+1)y})/4 (3)

G_{avg}=(B_{(x-1)y}+G_{x(y-1)}+G_{x(y+1)}+G_{(x+1)y})/4 (4)

The symbol b_{xy} indicates the interpolated blue pixel value in a red pixel, x indicates a row, y indicates a column, symbols B_{(x-1)y}, B_{x(y-1)}, B_{x(y+1)}, and B_{(x+1)y} indicate pixel values of adjacent pixels to the red pixel, G_{xy} indicates a green pixel value of a green pixel corresponding to the red pixel, and each of G_{(x-1)y}, G_{x(y-1)}, G_{x(y+1)}, and G_{(x+1)y} indicate pixel values of adjacent pixels to the green pixel.

For example, the interpolated blue pixel value b22 may be computed using blue pixel values B₁₂, B₂₁, B₂₃, and B₃₂ of adjacent blue pixels 73, 75, 77, and 79 to the red pixel 71 and green pixel values G₂₂, G₁₂, G₂₁, G₂₃, and G₃₂ of green pixels. When the blue pixel value b₂₂ is interpolated based on Equations 2 to 4, Constant Hue based interpolation may be defined.

In accordance with another embodiment, a blue pixel value may be interpolated based on Equations 5, 6, and 7.

When G_{H}>G_{V}+TH, b_{xy}=G_{xy}+(B_{avg, V}−G_{avg, V}) (5)

When G_{H}<G_{V}+TH, and G_{V}>G_{H}+TH, b_{xy}=G_{xy}+(B_{avg, H}−G_{avg, H}) (6)

When G_{H}<G_{V}+TH, and G_{V}<G_{H}+TH, b_{xy}=G_{xy}+(B_{avg}−G_{avg}) (7)

The G_{V}, the G_{H}, the B_{avg, V}, the B_{avg, H}, the G_{avg}, the G_{avg, H}, the B_{avg} and the G_{avg} may be computed based on Equations 8 to 15:

G_{V}=|G(x−1)y−G(X−1)(y−1)|+|Gxy−Gx(y−1)|+|G(x+1)y−G(x+1)(y−1)| (8)

G_{H}=|G_{(x-1)(y-1)}−G_{x(y-1)|}+|G_{x(y+1)}−G_{xy}|+|G_{(x+1)(y+1)}−G_{(x+1)y}| (9)

B_{avg, V}=(B_{(x-1)y}+B_{(x+1)y})/2 (10)

B_{avg, H}=(B_{x(y-1)}+B_{x(y+1)})/2 (11)

G_{avg, V}=(G_{(x-1)y}+G_{(x+1)y})/2 (12)

G_{avg, H}=(G_{x(y-1)}+G_{x(y+1)})/2 (13)

B_{avg}=(B_{(x-1)y}+B_{x(y-1)}+B_{x(y+1)}+B_{(x+1)y})/4 (14)

G_{avg}=(G_{(x-1)y}+G_{x(y-1)}+G_{x(y+1)}+G_{(x+1)y})/4 (15)

The symbol b_{xy} indicates the first interpolated pixel value in the first pixel, x indicates a row, y indicates a column, each of the B_{(x-1)y}, B_{x(y-1)}, B_{x(y+1)}, and B_{(x+1)y} indicates a pixel value of adjacent pixels to the first pixel, G_{xy} indicates the second pixel value of the second pixel corresponding to the first pixel, each of the G_{(x-1)(y-1)}, G_{(x-1)y}, G_{(x-1)(y+1)}, G_{x(y-1)}, G_{x(y+1)}, G_{(x+1)(y-1)}, G_{(x+1)y}, and G_{(x+1)(y+1)} indicates a pixel value of adjacent pixels to the second pixel, and the TH indicates a threshold value.

When the first interpolated pixel value b_{xy} is interpolated based on Equations 5 to 15, edge sensing interpolation may be defined. Similarly, the interpolated red pixel value may be computed using pixel values of adjacent pixels.

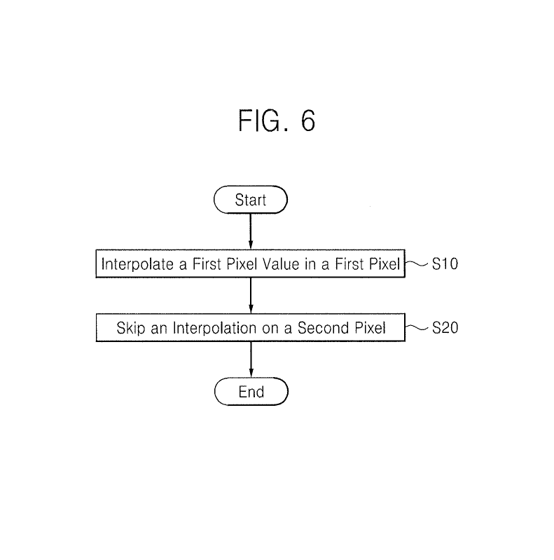

FIG. 6 illustrates operations included in one embodiment of a method for interpolating a color illustrated in FIG. 5. Referring to FIGS. 1 to 6, the image signal processor 220 interpolates a first pixel value b₂₂ based on pixel values B₁₂, B₂₁, B₂₃, and B₃₂ of adjacent pixels 73, 75, 77, and 79 to a first pixel 71 in the first pixel 71(S10). For example, the first pixel 71 may be a red pixel. When the first pixel 71 is a red pixel, each of adjacent pixels 73, 75, 77, and 79 to the first pixel 71 is a blue pixel. According to an example embodiment, the first pixel 71 may be a blue pixel. When the first pixel 71 is a blue pixel, each of adjacent pixels 73, 75, 77, and 79 to the first pixel 71 is a red pixel. The image signal processor 220 skips an interpolation on a second pixel G (S20).

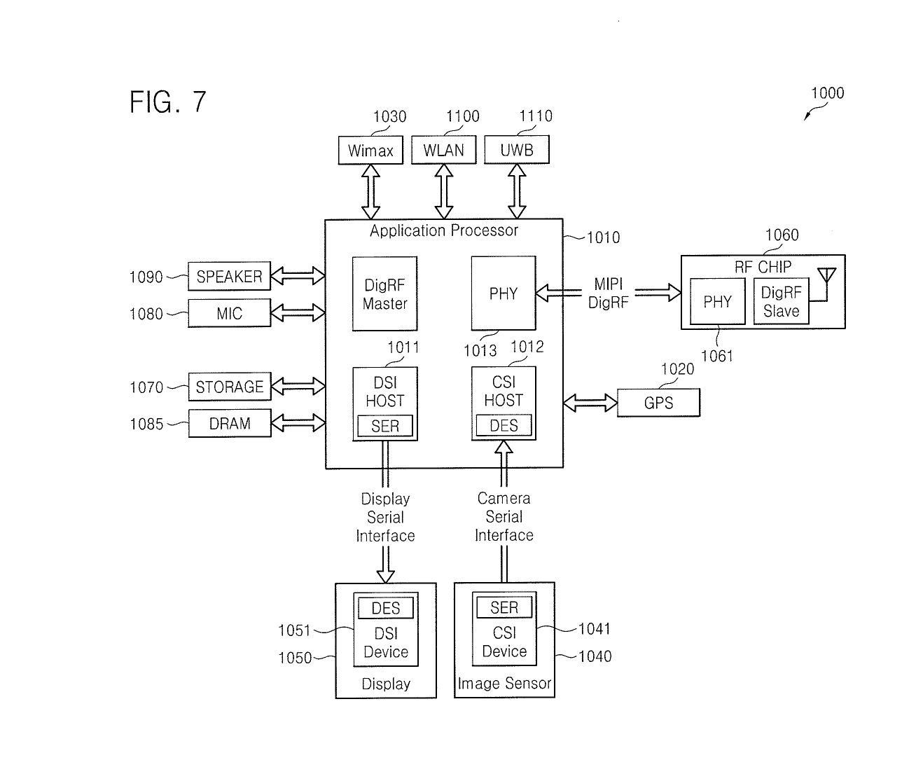

FIG. 7 illustrates another embodiment of an image system including the pixel array illustrated in FIG. 1. Referring to FIG. 7, an image sensing system 1000 may be embodied in a portable electronic device which may use or support a MIPI® interface, e.g., a cellular phone, a PDA, a PMP, or a smart phone. The image sensing system 1000 includes an application processor 1010, an image sensor 1040, and a display 1050.

A CSI host 1012 embodied in the application processor 1010 may perform a serial communication with a CSI device 1041 of the image sensor 1040 through a camera serial interface (CSI). Here, for example, a deserializer (DES) may be embodied in the CSI host 1012, and a serializer (SER) may be embodied in the CSI device 1041. The image sensor 1040 indicates the image sensor 100 described in FIGS. 1 to 6.

A DSI host 1011 embodied in the application processor 1010 may perform a serial communication with a DSI device 1051 of the display 1050 through a display serial interface (DSI). Here, for example, a serializer (SER) may be embodied in the DSI host 1011, and a deserializer (DES) may be embodied in the DSI device 1051.

The image sensing system 1000 may further include a RF chip 1060 which may communicate with the application processor 1010. A PHY 1013 of the image sensing system 1000 may transmit or receive data to/from a PHY 1061 of the RF chip 1060 according to MIPI DigRF.

The image sensing system 1000 may further include a GPS receiver 1020, a storage 1070, a mike 1080, a DRAM 1085, and a speaker 1090. The image sensing system 1000 may communicate using a Wimax 1030, a WLAN 1100, and a UWB 1110.

A method and a device for interpolating a color according to the aforementioned embodiments may decrease computational complexity of a demosaicing algorithm and hardware resources for executing the demosaicing algorithm by suggesting the demosaicing algorithm.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method for interpolating a color, comprising:
interpolating, in a first pixel of a first color, a first pixel value based on pixel values of pixels adjacent to the first pixel;
skipping an interpolation on a second pixel of a second color corresponding to the first pixel of the first color; and
generating an image based on the interpolated first pixel value and an uninterpolated pixel value of the second pixel.

2. The method as claimed in claim 1, wherein:
the first pixel is included in a first layer,
the second pixel is included in a second layer, and
the first layer and the second layer are vertically stacked.

3. The method as claimed in claim 2, wherein:
the first layer has a pattern of pixels of the first color and a third color, and
the second layer includes pixels of the second color corresponding to the pixels the pattern of the first layer.

4. The method as claimed in claim 3, wherein the pattern includes an alternating pattern of pixels of the first color and the third color.

5. The method of claim 2, wherein the first layer is over the second layer.

6. The method of claim 2, wherein the second layer is over the first layer.

7. The method as claimed in claim 1, wherein the first interpolated pixel value in the first pixel is computed by Bilinear interpolation.

8. The method as claimed in claim 1, wherein the first interpolated pixel value in the first pixel is computed by Constant Hue base interpolation.

9. The method as claimed in claim 1, wherein the first interpolated pixel value in the first pixel is computed by edge sensing interpolation.

10. A device comprising:
a pixel array including a first layer having a first pixel and a second layer having a second pixel; and
an image signal processor that interpolates a first pixel value in the first pixel based on pixel values of pixels adjacent to the first pixel output from the pixel array, skips interpolation of the second pixel, and generates an image based on the interpolated first pixel value and an uninterpolated pixel value of the second pixel.

11. The device as claimed in claim 10, wherein the first layer and the second layer are vertically stacked.

12. The device as claimed in claim 10, wherein the first layer include:
a third pixel, and
the first pixel and the third pixel are disposed in a predetermined pattern.

13. The device as claimed in claim 12, wherein the predetermined pattern is an alternating pattern of first and third pixels.

14. The device as claimed in claim 10, wherein the first interpolated pixel value in the first pixel is computed by Bilinear interpolation.

15. The device as claimed in claim 10, wherein the first interpolated pixel value in the first pixel is computed by Constant Hue based interpolation.

16. The device as claimed in claim 10, wherein the first interpolated pixel value in the first pixel is computed by edge sensing interpolation.

17. The device as claimed in claim 10, wherein the first pixel is a blue pixel or a red pixel.

18. The device as claimed in claim 10, wherein the second pixel is a green pixel.

19. The device as claimed in claim 10, wherein the second layer is formed of an organic photoelectric-conversion film.

20. The device as claimed in claim 10, wherein:
the first layer has a pattern of pixels of the first color and a third color, and
the second layer includes pixels of the second color corresponding to the pixels the pattern of the first layer, wherein the pattern of pixels includes an alternating pattern of pixels of the first and third colors.
